(19) United States
(12) Patent Application Publication
(10) Pub. No.: US 2014/0283662 A1
(43) Pub. Date: Sep. 25, 2014

(54) APPARATUS AND NON-TRANSITORY COMPUTER-READABLE MEDIUM

(71) Applicant: Masashi Tokura, Konan-shi (JP)

(72) Inventor: Masashi Tokura, Konan-shi (JP)

(73) Assignee: BROTHER KOGYO KABUSHIKI KAISHA, Nagoya-shi (JP)

(21) Appl. No.: 14/219,396

(22) Filed: Mar. 19, 2014

(30) Foreign Application Priority Data
Mar. 19, 2013 (JP) 2013-056421

(51) Int. Cl. B26D 5/00; B41J 25/304

(52) U.S. Cl. CPC B26D 5/007; B41J 25/304
USPC 83/76.1; 347/110

(57) ABSTRACT

An apparatus includes a cartridge holder configured to receive a pen or a cutter, a platen configured to receive an object, a moving mechanism configured to move the cartridge holder in a direction that the cartridge holder comes close to the platen, a read unit configured to read image data from the object, a receiving unit configured to receive an instruction to set a first mode or a second mode, and a processor configured to instruct the apparatus to generate processing data to move the moving mechanism based on the image data, to store the processing data in a storage device of the apparatus in response to receiving the instruction to set the first mode, and to instruct the moving mechanism to move the cartridge holder close to the platen, based on the processing data, in response to receiving the instruction to set the second mode.

### CROSS-REFERENCE TO RELATED APPLICATIONS

This application is based upon and claims the benefit of priority from the prior Japanese Patent Application No. 2013-056421 filed on Mar. 19, 2013, the entire contents of which are incorporated herein by reference.

### BACKGROUND

1. Technical Field

The present disclosure relates to an apparatus provided with a cartridge holder receiving a pen or a cutter and a non-transitory computer-readable medium storing data of instructions for the apparatus.

2. Related Art

Cutting plotters have been conventionally known as an apparatus automatically executing a cutting process. An object to be cut is a sheet-shaped object (paper sheet, for example). The sheet is held on a base material having an adhesive layer on a surface thereof. The sheet is applied to the adhesive layer. The cutting plotter moves the base material holding the sheet, in a first direction while holding both ends of the base material vertically between a driving roller and a pinch roller. The cutting plotter further moves a carriage with a cutting blade in a second direction perpendicular to the first direction. A desired pattern is cut out of the sheet by the above-described operation.

### SUMMARY

The cutting plotter has been proposed to be equipped with an image reading device provided with a scanner. In this case, a user sets a sheet printed with a pattern on the cutting plotter. An image of the sheet surface is then read by the scanner, so that cutting data of the pattern can be generated on the basis of the image data. The cutting plotter then executes a cutting process based on the generated cutting data, with the result that a pattern which is the same as printed on the sheet can be cut out of the sheet.

The users are sometimes desirous to cut the same configuration as the pattern printed on the sheet out of another sheet, instead of cutting the pattern out of the sheet. However, when this demand is met, there arises a problem that the operation by the user becomes complicate.

Therefore, an object of the disclosure is to provide an apparatus which can apply appropriate processing based on image data read by the read unit and a non-transitory computer-readable medium storing data of instructions for the apparatus.

The present disclosure provides an apparatus comprising a cartridge holder configured to receive a pen or a cutter, a platen configured to receive an object, a moving mechanism configured to move the cartridge holder in a direction that the cartridge holder comes close to the platen, a read unit configured to read image data from the object, a receiving unit configured to receive an instruction to set a first mode or a second mode, and a processor configured to instruct the apparatus to generate processing data to move the moving mechanism based on the image data, store the processing data in a storage device of the apparatus in response to receiving the instruction to set the first mode, and instruct the moving mechanism to move the cartridge holder close to the platen, based on the processing data, in response to receiving the instruction to set the second mode.

The disclosure further provides a non-transitory computer-readable medium for an apparatus comprising a cartridge holder configured to receive a pen or a cutter, a platen configured to receive an object, a moving mechanism configured to move the cartridge holder in a direction that the cartridge holder comes close to the platen, a read unit configured to read image data from the object, and a receiving unit configured to receive an instruction to set a first mode or a second mode. The computer-readable medium storing computer-readable instructions, when executed by a processor of the apparatus, cause the apparatus to generate processing data to move the moving mechanism based on the image data, store the processing data in a storage device of the apparatus in response to receiving the instruction to set the first mode, and instruct the moving mechanism to move the cartridge holder close to the platen so that the object is processed, based on the processing data, when the receiving unit receives the instruction to set the second mode.

The disclosure still further provides an apparatus comprising a pen or a cutter, a platen configured to receive an object, a moving mechanism configured to move the cartridge holder in a direction that the pen or the cutter comes close to the platen, a read unit configured to read image data from the object, a receiving unit configured to receive an instruction to set a first mode or a second mode, and a processor configured to instruct the apparatus to generate processing data to move the moving mechanism based on the image data, store the processing data in a storage device of the apparatus in response to receiving the instruction to set the first mode, and instruct the moving mechanism to move the pen or the cutter close to the platen so that the object is processed, based on the processing data, in response to receiving the instruction to set the second mode.

### BRIEF DESCRIPTION OF THE DRAWINGS

In the accompanying drawings:

FIG. 1 is an example of a perspective view of a processing apparatus, showing an inner structure thereof and a body cover;

FIG. 2 is an example of a plan view of the processing apparatus, showing the inner structure thereof;

FIG. 3 is art example of a front view of a processing head and its periphery;

FIGS. 4A and 4B are examples of front views of examples of a cutter cartridge and a pen cartridge respectively;

FIG. 5 is an example of a right side view of a cartridge holder and its vicinity with a cover member being partially broken in the state where the cartridge is attached;

FIG. 6 is an example of a schematic block diagram showing an electrical configuration of the apparatus;

FIG. 7 illustrates an example of a structure of processing data;

FIG. 8 illustrates an example of a pattern to which processing is applied based on processing data;

FIG. 9 illustrates an example of a mode switching screen;

FIG. 10 illustrates an example of a read screen in a first mode;

FIG. 11 illustrates an example of a read screen in a second mode;

FIG. 12 is an example of a processing start screen;

FIG. 13 is an enlarged view of the read screen, explaining designation of a region in the read screen;

FIG. 14 illustrates an example of a flowchart showing an entire processing flow including the first and second modes;

FIG. 15 is an example of a flowchart showing a flow of processing data generating process; and

FIG. 16 is similar to FIG. 13, showing a second example.

### DETAILED DESCRIPTION

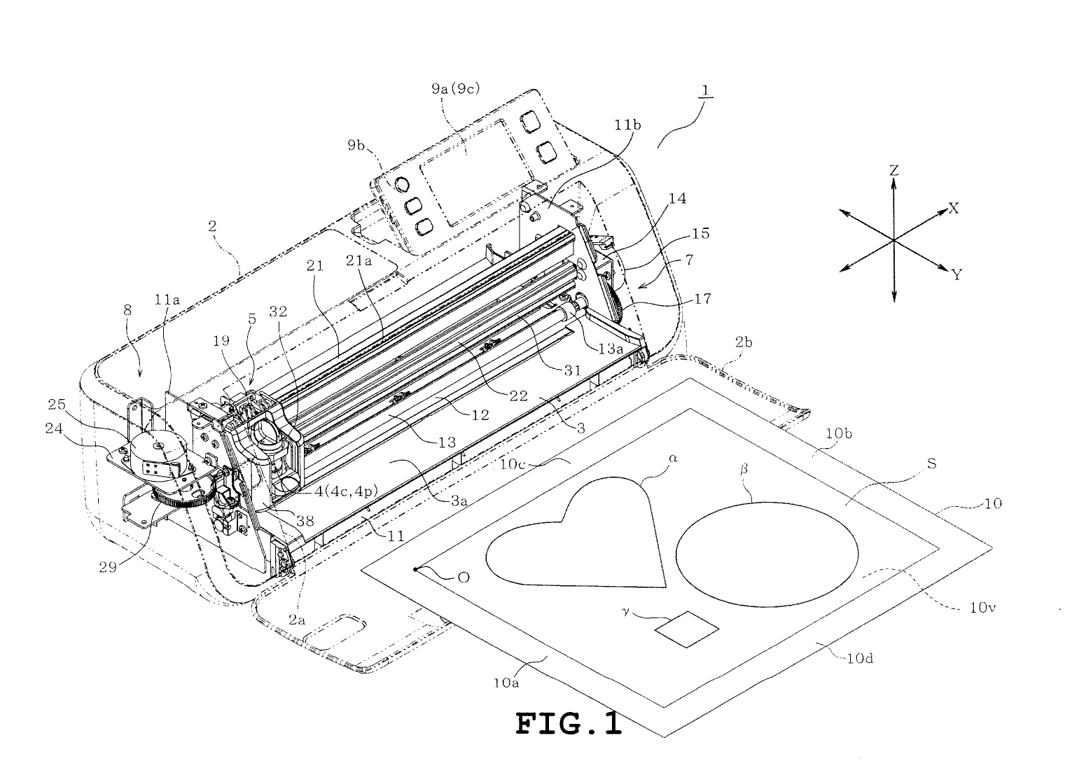

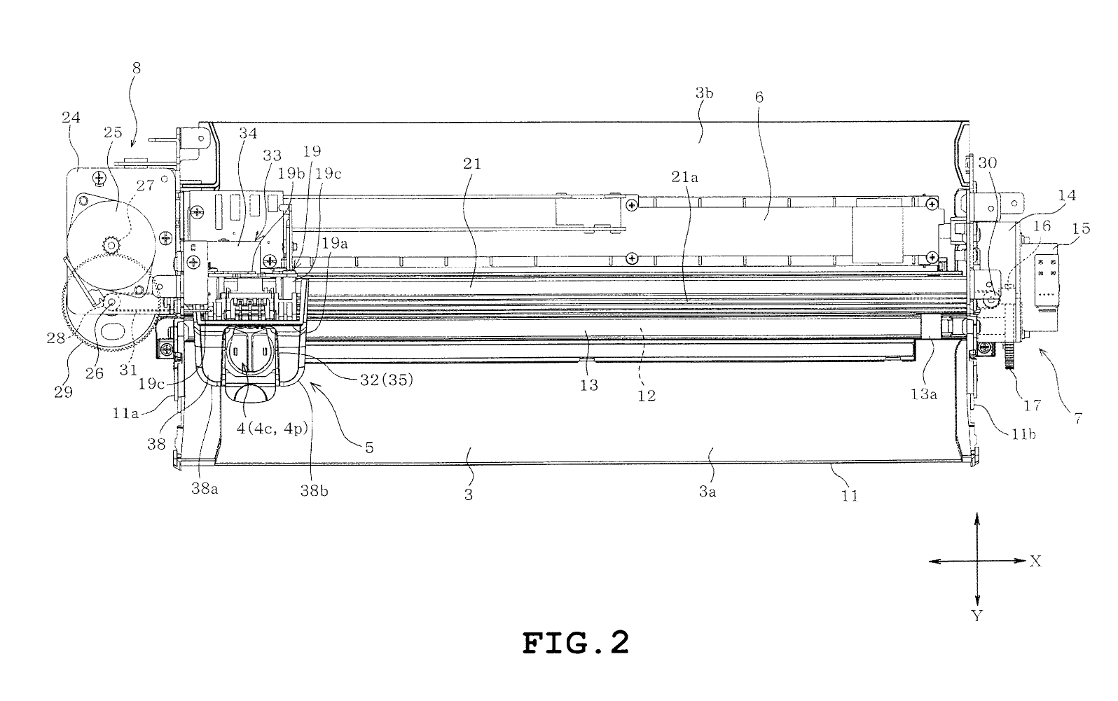

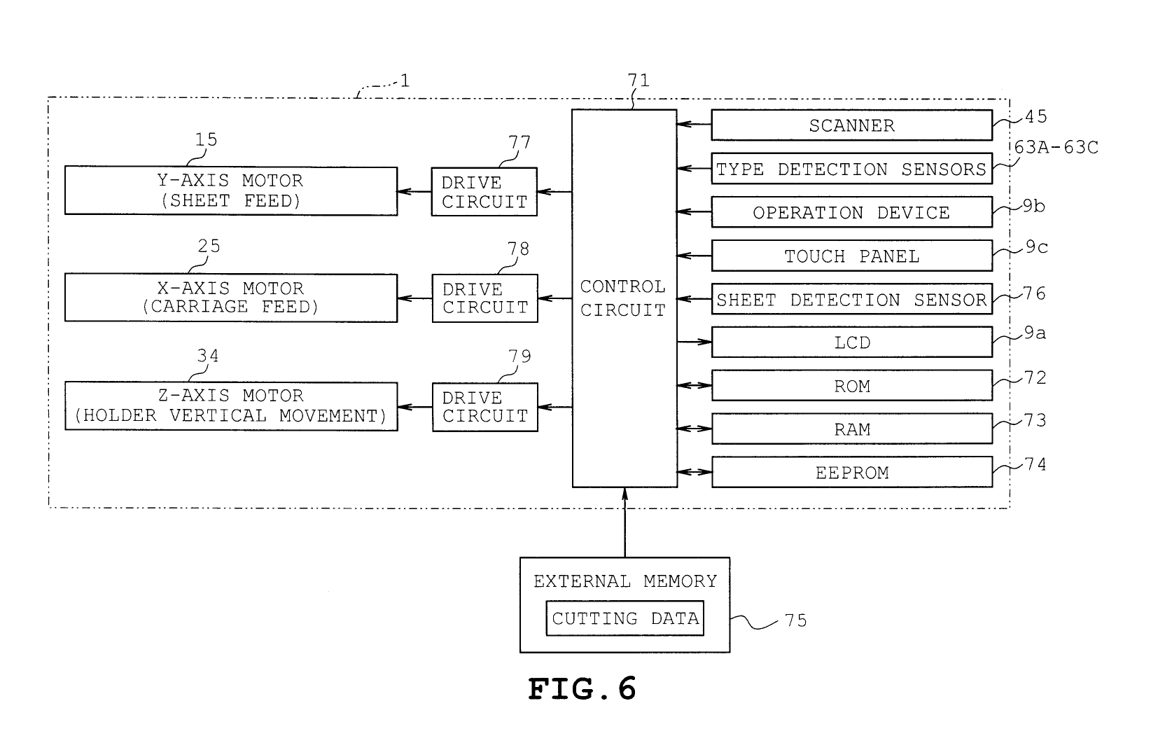

A first example of an apparatus will be described with reference to FIGS. 1 to 15. Referring to FIG. 1, a processing apparatus 1 is shown and includes a body cover 2 serving as a housing, a platen 3 provided in the body cover 2, a processing head 5 on which a cartridge 4 is to be mounted and a scanner 6 (see FIGS. 2 and 6) serving as an image reading unit. The processing apparatus 1 further includes a holding sheet 10 for holding an object S. The object S is to be processed by the processing apparatus 1 and to be read by the image reading unit.

In the processing apparatus 1, a plurality of cutter cartridges 4c of a cutter C and a plurality of pen cartridges 4p are prepared as the cartridge 4. One of the cartridges 4c and 4p is selectively attached to a cartridge holder 32 of a processing head 5 as will be described later. All the cartridges 4c and 4p include respective cases having substantially the same shape (see cases 50 in FIGS. 4A and 4B). All the cartridges 4c and 4p will be hereinafter referred to as “cartridge 4” for the sake of simplicity.

The body cover 2 is formed into the shape of a horizontally long rectangular box. The body cover 2 has a front formed with an opening 2a. A front cover 2b is mounted on the front of the body cover 2 to open and close the opening 2a. The holding sheet holding the object S is set onto the platen 3 while the opening 2a is open. The cartridge 4 is also attached to and detached from a cartridge holder 32 while the opening 2a is open.

The processing apparatus 1 includes a transfer mechanism 7 which transfers the holding sheet 10 set on the platen 3 in a predetermined transfer direction. The processing apparatus 1 also includes a head moving mechanism 8 which moves a processing head 5 in a direction intersecting with the transfer direction of the holding sheet 10 (for example, a direction perpendicular to the transfer direction). In the following description, the direction in which the holding sheet 10 is transferred by the transfer mechanism 7 will be referred to as “front-rear direction”. That is, the side of the opening 2a of the processing apparatus 1 will be referred to as “front” and the opposite side will be referred to as “rear.”

A display 9a and an operation switch device 9b including various operation switches are mounted on a right upper surface of the body cover 2. The display 9a is comprised of a full-color liquid display device and configured as a display unit which displays various patterns, images obtained by the scanner 6, necessary messages to the user, and the like. The operation device 9b is operated by the user when various input contents are entered. A touch panel 9c is placed on a display surface side of the display 9a. The touch panel 9c has a transparent matrix touch switch for coordinate input. The touch switch employs a resistance detection system. More specifically, the touch switch is configured of resistors arranged in a matrix at predetermined intervals. When the user touches any position on the touch switch with his/her finger, a point of intersection of the resistors corresponding to the touched position is scanned, whereby the touch position is detected. When operating the operation switches of the operation switch device 9b or the touch panel 9c, the user can designate an object to be displayed on a screen of the display 9a, select various patterns, switch various operation modes and set various parameters.

The platen 3 receives the underside of the holding sheet 10 when the object S is processed. The platen 3 includes a front platen 3a and a rear platen 3b and has a horizontal upper surface as shown in FIG. 2. The holding sheet 10 holding the object S is transferred while being placed on the platen 3. The holding sheet 10 is made of a synthetic resin material and formed into a rectangular sheet shape. The holding member 10 has an upper surface including peripheral edges 10a to 10d and an inner region to which an adhesive agent is applied thereby to be formed into an adhesive layer 10v (see FIG. 1). The user affixes the object S to the adhesive layer 10v with the result that the object S is held by the holding sheet 10. The adhesive layer 10v has an adhesive force which is set so that the object S is immovably held reliably in the cutting by the cutter C or the printing by the pen P and so that the object S can be easily removed after the processing. The transfer mechanism 7 and the head moving mechanism 8 are constructed into a relative movement unit which moves the holding sheet 10 holding the object S in the X direction and the processing head 5 in the Y direction relative to each other.

Firstly, the transfer mechanism 7 transfers the holding sheet 10 on the upper surface side of the platen 3 freely in the Y direction. A frame 11 is enclosed in the body cover 2 as shown in FIGS. 1 and 2. The frame 11 includes right and left sidewalls 11b and 11a which are located at right and left sides of the platen 3 so as to face each other, respectively. A driving roller 12 and a pinch roller 13 are mounted on both sidewalls 11a and 11b so as to be located in a space between the front and rear platens 3a and 3b. The driving roller 12 and the pinch roller 13 extend in the right-left direction and lined in the up-down direction. The pinch roller 13 is located above the driving roller 12.

The driving roller 12 has an upper end which is substantially level with the upper surface of the platen 3 and right and left ends mounted on the right and left sidewalls 11b and 11a respectively so that the driving roller 12 is rotatable. The right end of the driving roller 12 extends rightward through the right sidewall 11b as shown in FIG. 2. A driven gear 17 having a large diameter is secured to a right distal end of the driving roller 12. A mounting frame 14 is fixed to an outer surface of the right sidewall 11b. A Y-axis motor 15 comprised of a stepping motor, for example is mounted on the mounting frame 14. The Y-axis motor 15 has an output shaft to which is fixed a driving gear 16 which has a small diameter and is to be brought into mesh engagement with the driven gear 17.

The pinch roller 13 has right and left ends mounted on the right and left sidewalls 11b and 11a respectively so that the pinch roller 13 is rotatable and slightly displaceable in the up-down direction. Two springs (not shown) are mounted on the outer surfaces of the right and left sidewalls 11b and 11a to normally bias the pinch roller 13 downward. Accordingly, the pinch roller 13 is normally biased downward (to the driving roller 12 side) by the springs. Two rollers 13a having a slightly large diameter are mounted on the pinch roller 13 so as to be located near both ends thereof respectively. Only the right roller 13a is shown in FIGS. 1 and 2.

The right and left ends 10b and 10a of the holding sheet 10 are thus held between the driving roller 12 and the rollers 13a of the pinch roller 13. Upon drive of the Y-axis motor 15, normal or reverse rotation of the Y-axis motor 15 is transmitted via the gears 16 and 17 to the driving roller 12, whereby the holding sheet 10 is transferred rearward or forward together with the object S. The transfer mechanism 7 is thus constituted by the driving roller 12, the pinch roller 13, the Y-axis motor 15 and the gears 16 and 17 serving as a reduction mechanism.

The head moving mechanism 8 serves to move the carriage 19 of the processing head 5 freely in the X direction. More specifically, as shown in FIGS. 1 and 2, a pair of guide rails 21 and 22 are fixed to the right and left sidewalls 11b and 11a so as to be located slightly rear above the pinch roller 13. The guide rails 21 and 22 extend in the right-left direction substantially in parallel to the pinch roller 13. Guide grooves are formed in an upper surface of the guide rail 21 and an underside of the guide rail 22 so as to extend between the right and left ends although only the guide groove 21a of the upper surface is shown.

Furthermore, the carriage 19 has a pair of protrusions engaging the guide grooves 21a and 21b respectively although the grooves are not shown. The protrusions are formed on the upper and lower sides so as to hold the guide grooves 21a therebetween in the up-down direction. Thus, the carriage 19 is supported by the engagement of the protrusions and the guide grooves 21a so as to be slidable on the guide rails 21 and 22 in the right-left direction.

A horizontal mounting frame 24 is fixed to the outer surface of the left sidewall 11a so as to be located near the rear of the left sidewall 11a at the outer surface side, as shown in FIGS. 1 and 2. An X-axis motor 25 is mounted on a rear part of the left mounting frame 24 to a downward direction. Furthermore, a vertically extending pulley shaft 26 (see FIG. 2) is mounted on the mounting frame 24. The X-axis motor 25 is comprised of a stepping motor, for example and has an output shaft to which a driving gear 27 having a small diameter is fixed. A timing pulley 28 and a driven gear 29 having a large diameter are rotatably mounted on the pulley shaft 26. The timing pulley 28 and the driven gear 29 are configured to be rotated together.

On the other hand, a timing pulley 30 is mounted on the right mounting frame 14 so as to be rotatable about an axis extending in the up-down direction. An endless timing belt 31 horizontally extends between the timing pulleys 30 and 28 in the right-left direction. The timing belt 31 has a midway part joined to a mounting part (not shown) of the processing head 5.

Upon drive of the X-axis motor 25, normal or reverse rotation of the X-axis motor 25 is transmitted via the gears 27 and 29 and the timing pulley 28 to the timing belt 31, whereby the processing head 5 is moved leftward or rightward together with the carriage 19. Thus, the carriage 19 is moved freely in the right-left direction perpendicular to the direction in which the object S is conveyed. The head moving mechanism 8 is thus constituted by the guide rails 21 and 22, the X-axis motor 25, the gears 27 and 29 serving as a reduction mechanism, the timing pulleys 28 and 30, the timing belt 31 and the like.

The processing head 5 includes an up-down drive mechanism 33 and a cartridge holder 32 disposed in the rear and in front of the carriage 19 as shown in FIG. 2. The up-down drive mechanism 33 is configured to drive the cartridge holder 32 in the up-down direction (the Z direction) together with the cartridge 4. The carriage 19 includes front and rear walls 19a and 19b and upper and lower arms 19c and 19d connecting the walls 19a and 19b, as shown in FIGS. 2, 3 and 5. Thus, the carriage 19 is shaped so as to surround the front and rear sides and upper and lower sides of the guide rails 21 and 22. A Z-axis motor 34 (see FIG. 2) is mounted so that an axis thereof is directed frontward. The Z-axis motor 34 is comprised of a stepping motor, for example. A transmission mechanism (not shown) is provided between the Z-axis motor 34 and the cartridge holder 32. The transmission mechanism reduces a rotational speed of the Z-axis motor 34 and converts rotation of the Z-axis motor 34 to up-down movement of the cartridge holder 32, transmitting the up-down movement. The transmitting mechanism and the Z-axis motor 34 constitute an up-down drive mechanism 33.

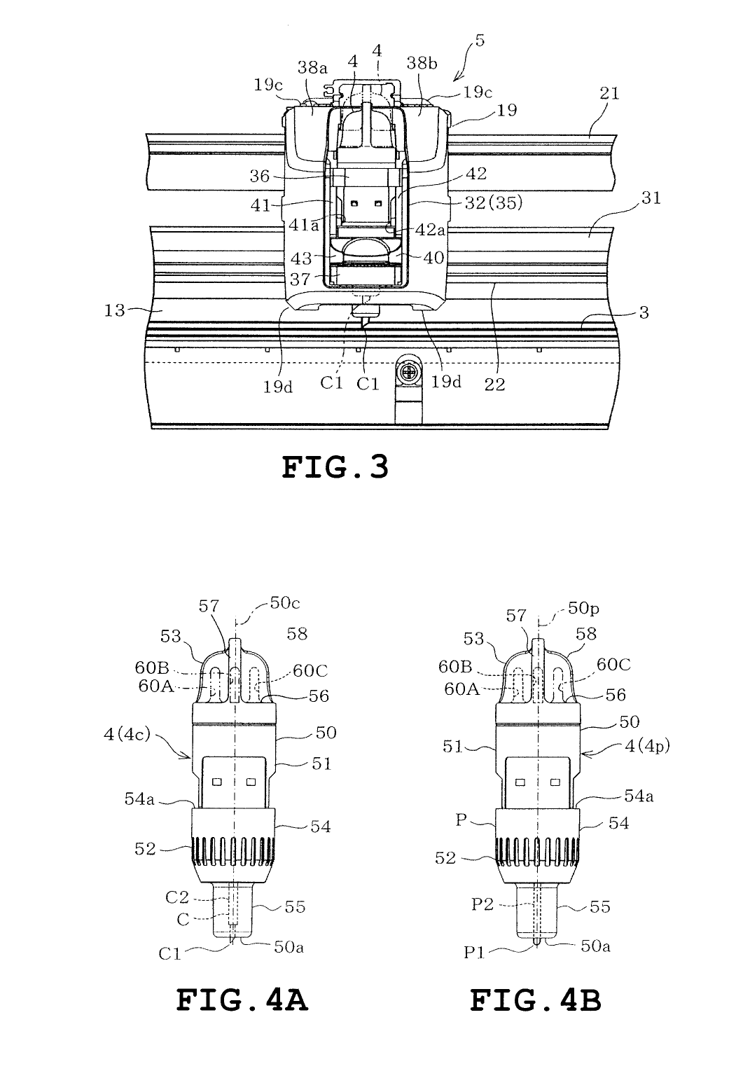

Upon drive of the Z-axis motor 34, normal or reverse rotation of the Z-axis motor 34 is converted via the transmission mechanism to the up-down movement, whereby the cartridge holder 32 is moved upward or downward together with the cartridge 4. As a result, the cartridge holder 32 is moved together with the cartridge 4 between a lowered position and a raised position. When located at the lowered position, the cartridge 4 of the cartridge holder 32 carries out cutting by a cutter C or printing by a pen P as shown in FIGS. 4A and 4B. When the cartridge 4 of the cartridge holder 32 is located at the raised position, the blade edge C1 or the pen tip P1 is spaced away from the object S by a predetermined distance (see two-dot chain line in FIG. 3).

When the cartridge 4c of the cutter C is attached to the cartridge holder 32 and is located at the lowered position, the blade edge C1 penetrates the object S. Pressure of the blade edge C1 for the cutting in this case will be referred to as “cutter pressure.” On the other hand, when the cartridge 4p of the pen P is attached to the cartridge holder 32 and is located at the lowered position, the pen tip P1 abuts on the object S. Pressure of the pen tip P1 for the cutting in this case will be referred to as “pen pressure.” The cutter pressure and the pen pressure are set to pressure values suitable for the cutting and the printing by a control circuit 71 based on an amount of rotation of the Z-axis motor 34, respectively.

The cartridge holder 32 includes a holder frame 35 and upper and lower holders 36 and 37 as shown in FIGS. 2, 3 and 5. The holder frame 35 is driven upward and downward by the up-down drive mechanism 33. The upper and the lower holders 36 and 37 are fixed to the holder frame 35. More specifically, a cover member 38 is provided on the front wall 19a of the carriage 19 so as to cover right and left sides of the front wall 19a from front. The holder frame 35 serving as movable part is disposed between a left projection part 38a and a right projection 38b of the cover member 38. The holder frame 35 is formed into a C-shape (see FIG. 2) and has a top, underside and front all of which are open. The upper and lower holders 36 and 37 are attached so that the cartridge 4 is inserted through the both holders from above. The upper and lower holders 36 and 37 are each formed into a frame shape housed in the holder frame 35.

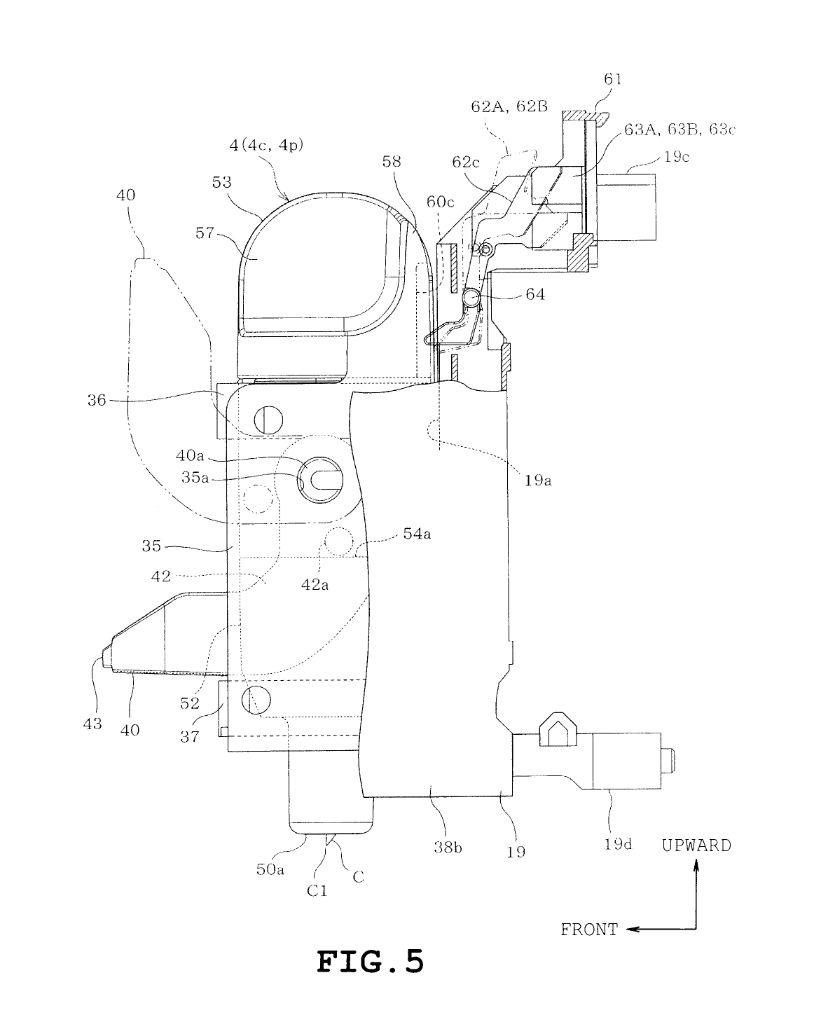

The holder frame 35 is provided with a lever member 40 located between the upper and the lower holders 36 and 37 as shown in FIGS. 3 and 5. The lever member 40 has a pair of right and left arms 41 and 42 and an operating portion 43 which is provided so as to connect between distal end sides of the arms 41 and 42. Furthermore, the lever member 60 has a proximal end formed with pivot portions 40a and 40b located at outer surface sides of the arms 41 and 42 respectively. Only the right pivot portion 40a is shown in FIG. 5. The holder frame 35 has right and left sidewalls formed with circular holes respectively. Only right circular hole 35a is shown. The pivot portions 40a and 40b are inserted through circular holes 35a respectively. The arms 41 and 42 include respective inner surface sides provided with small columnar engagement portions 41a and 42a (see FIGS. 3 and 5). The engagement portions 41a and 42a are formed so as to be engageable with engaged portions 54a of the cartridge 4 respectively.

As a result, the lever member 40 is swung about the pivot portions 40a serving as a center of swinging motion so as to be switchable between an open position shown by alternate long and two short dashes line in FIG. 5 and a fixed position show by solid line in FIG. 5. As shown in FIG. 5, the engagement portions 41a and 42a engage the engaged portions 54a respectively when the lever member 40 is located at the fixed position. As the result of the engagement, the cartridge 4 is fixed to the lower holder 37 (the cartridge holder 32). On the other hand, when operated so as to be pulled frontward, the lever member 40 is swung from the fixed position to the open position. With this swing, the engagement portions 41a and 42a depart from the respective engaged portions 54a, whereby the lever member 40 is released from the fixed state.

The cartridge 4 which is detachably attached to the cartridge holder 32 will now be described. FIGS. 4A and 4B exemplify cartridges 4c and 4p of the cutter C and the pen P respectively. As shown, the cartridge 4c of the cutter C and the cartridge 4p of the pen P include the same case 50 and are selectively attached to the cartridge holder 32. More specifically, the case 50 includes a case body 51, the cap 52 and a knob 53. The cap 52 and the knob 53 are provided on one end and the other end of the body 51 respectively. The case body 51 is formed into a cylindrical shape and extends in the up-down direction.

The cap 52 includes a larger-diameter portion 54 and a smaller-diameter portion 55 and is accordingly formed into the shape of a stepped bottomed cylindrical container. The larger-diameter portion 54 is fitted with a lower end of the case body 51. The larger-diameter portion 54 has an upper end serving as an engaged portion 54a which abuts on the engagement portions 41a and 42a of the lever member 40. The larger-diameter portion 54 has a lower end which is fitted with the lower holder 37 of the cartridge holder 32. The cap 52 has an underside 50a formed into a flat shape. The underside 50a has a through hole (not shown) through which the blade edge C1 of the cutter C or the pen tip P1 is inserted. The knob 53 has a cover plate 56, a knob plate 57 and a rear plate 58 both provided on an upper part of the cover plate 56. The cover plate 56 is fixed to an upper end of the case body 51. The knob plate 57 is mounted on a central part of the cover plate 56 in the right-left direction so as to be directed vertically.

The cartridge 4c shown in FIG. 4A includes the cutter C serving as a cutting unit. The cutter C has a proximal end or a cutter shaft C2 and a distal end (a lower end) or the blade edge C1, both of which are formed integrally with the cutter C. The cutter shaft C2 is formed into a round bar shape and is housed in the case 50. The blade of the cutter C is formed into a substantially triangular shape tilted relative to the object S although not shown in detail in the drawings. Furthermore, bearings are provided in the case body 51 to support the cutter shaft C2 so that the cutter shaft C2 is rotatable about a central axis 50c thereof. The blade edge C1 protrudes from the underside 50a of the cap 52. The cartridge 4c is constructed so that a central axis 50c of the cutter shaft C2 corresponds with a central axis of the cap 52.

The cartridge 4p shown in FIG. 4B is a printing instrument formed into the pen P and has a distal end or the pen tip P1 from which ink is caused to seep. An ink tank (not shown) is provided in the case body 51 to supply ink to a pen tip member 49. The pen tip P1 protrudes from the underside 50a of the cap 52. The cartridge 4p is constructed so that a central axis 50p of the pen tip P1 corresponds with a central axis of the cap 52.

Any one of three grooves 60A to 60C is formed in the rear plate 58 of the knob 53 so that the rear plate 58 is a concavo-convex portion, as shown in FIGS. 4A and 4B. The grooves 60A to 60C have different concavo-convex patterns according to types of the cartridges 4. More specifically, for example, the cutting cartridge 4c or the printing cartridge 4p can be discriminated based on presence or absence of the groove 60C at the right end of the rear plate 58, as shown in FIGS. 4A and 4B. In other words, for example, the cartridges 4c and 4p as shown in respective FIGS. 4A and 4B differ from each other in the presence or absence of the groove 60C at the right end of the rear plate 58. The groove 60C can discriminate between the cutting cartridge 4c and the printing cartridge 4p. Furthermore, for example, the color type of the pen P can be discriminated based on presence or absence of the grooves 60A and 60B of the cartridge 4p.

The carriage 19 is provided with a detection unit which is located at an upper side facing the rear plate 58 of the cartridge 4, as shown in FIG. 5. The detection unit may include, for example, three contacts 62A to 62C and three type detection sensors 63A to 63C all provided on a substrate holder 61.

The type detection sensors 63A to 63B mounted on a substrate of the substrate holder 61 so as to be arranged from side to side. The type detection sensors 63A to 63C are comprised of optical sensors (photointerrupters). The contacts 62A to 62C are formed into the shape of a plate extending over the side of the type detection sensors 63A to 63C. The contacts 62A to 62C have lengthwise middle portions formed with shafts 64 respectively. The substrate holder 61 is provided with bearings (not shown) swingably supporting the shafts 64 respectively. The contacts 62A to 62C are supported by the respective bearings so as to be lined in the direction of plate thickness. Three extension coil springs (not shown) extend between upper portions of the contacts 62A to 62C and the substrate holder 61 respectively. The contacts 62A to 62C are biased by the extension coil springs in a direction such that the upper portions of contacts 62A to 62C are tilted toward the type detection sensors 63A to 63C respectively. In other words, the biasing forces of the extension coil springs act in a direction such that lower ends of the contacts 62A to 62C come into contact with the rear plate 58 of the knob 53.

For example, when the cartridge 4c of the cutter C is attached to the cartridge holder 32, the lower ends of the contacts 62A and 62B come into contact with the rear plate 58, thereby swinging. With the swinging, the upper ends of the contacts 62A and 62B are departed from the type detection sensors 63A and 63B respectively (see two-dot chain line in FIG. 5). On the other hand, the lower end of the other contact 62C remains tilted toward the groove 60C of the rear plate 58. Accordingly, the upper end of the contact 62C is fitted at the type detection sensor 63C side.

The cartridge 4c of the cutter C is attached to the cartridge holder 32 in cutting the object S. In this case, the control circuit 71 identifies the type of the cartridge 4c, based on detection signals of the contacts 62A to 62C generated by the type detection sensors 63A to 63C respectively. The control circuit 71 then controls the up-down drive mechanism 33 to move the cartridge 4c to the lowered position and sets the blade edge C1 to the above-mentioned cutter pressure. In this case, the blade edge C1 penetrates the object S on the holding sheet 10 to be put slightly into the holding sheet 10. In this state, the holding sheet 10 and the cartridge 4c (the cutter C) are moved in the X and Y directions relative to each other by the transfer mechanism 7 and the head moving mechanism 8, respectively. The cutting of the object S is executed by this relative movement.

On the other hand, the cartridge 4p of the pen P is attached to the cartridge holder 32 in printing the object S. In this case, the control circuit 71 identifies the type of the cartridge 4p, based on detection signals of the contacts 62A to 62C generated by the type detection sensors 63A to 63C respectively. The control circuit 71 then controls the up-down drive mechanism 33 to move the cartridge 4p to the lowered position and sets the pen tip P1 to the above-mentioned pen pressure. In this case, the pen tip P1 penetrates the object S. In this state, the holding sheet 10 and the cartridge 4p (the pen P) are moved in the X and Y directions relative to each other by the transfer mechanism 7 and the head moving mechanism 8, respectively. The printing of the object S is executed by this relative movement. An XY coordinate system with a left corner of the adhesive layer 10v serving as an origin O is set in the processing apparatus 1, as shown in FIG. 1. The above-described relative movement of the holding sheet 10 (the object S) and the processing head 5 (the cutter C or the pen P) is carried out on the basis of the XY coordinate system.

The processing apparatus 1 according to the example is provided with a scanner 6 serving as an image obtaining unit shown in FIG. 2. The scanner 6 is comprised of a contact image sensor (CIS), for example. The scanner 6 includes a line sensor including a plurality of image pickup devices lined in the right-left direction, a light source (a lamp) and lens, all of which are composed integrally. The scanner 6 has a length substantially the same as the width of the holding sheet 10 and extends in the right-left direction. The scanner 6 is disposed in the rear of the guide rail 22 and directed downward. The scanner 6 has an underside having a read part which reads an image on the surface of the object S while being in proximity to the upper surface of the object S.

The scanner 6 is controlled by the control circuit 71. More specifically, the control circuit 71 controls the transfer mechanism 7 to move the holding sheet 10 rearward or in the Y direction. The control circuit 71 controls the scanner 6 so that a reading operation by the scanner 6 (scanning in the X direction) is repeatedly executed in synchronization with the movement of the holding sheet 10. The control circuit 71 obtains two-dimensional image data of the object S by the above-described control manner. The carriage 19 has an underside provided with a sheet detection sensor 76 (see FIG. 6). The sheet detection sensor 76 detects a distal end position of the holding sheet 10 set on the platen 3 and accordingly a Y-directional position of the holding sheet 10. A detection signal generated by the sheet detection sensor 76 is supplied to the control circuit 71.

Furthermore, the control circuit 71 is configured to process the image data of the object S read by the scanner 6 in a known image processing manner. In this case, the control circuit 71 extracts patterns, colors of patterns α to γ (see FIG. 1) affixed to the object S, and the like. Based on data of the extracted patterns, colors and the like, the control circuit 71 controls the display 9a and generates cutting or printing data of the patterns. A coordinate system of the image data is specified so as to correspond to the XY coordinate system of the processing apparatus 1.

The control system of the processing apparatus 1 will be described with reference to FIG. 6. The control circuit 71 is a control unit controlling the entire processing apparatus 1. The control circuit 71 is mainly configured of a computer (CPU). To the control circuit 71 are connected a ROM 72, a RAM 73, an EEPROM 74 and an external memory 75. The ROM 72 stores a cutting control program, a printing control program, a display control program, a cutting data generation program, a printing data generation program, a data processing program which will be described later. The cutting control, program is provided for controlling a cutting operation. The printing control program is provided for controlling a printing operation. The display control program is provided for a displaying operation of the display 9a. The cutting data generation program is provided for generating cutting data based on the above-mentioned image data. The printing data generation program is provided for generating printing data based on the image data. The external memory 75 stores the cutting data and the printing data. The cutting data is provided for cutting a plurality of types of patterns. The printing data is provided for printing a plurality of types of patterns.

Signals are supplied to the control circuit 71 from the sheet detection sensor 76, the type detection sensors 63A to 63C, the scanner 6 and the like. To the control circuit 71 are connected the display 9a, the touch panel 9c and various operation switches of the operation device 9b. While viewing a display screen of the display 9a, the user operates various switches of the operation device 9b or the touch panel 9c. As a result, the user can select a desired pattern and set various processing modes and parameters. To the control circuit 71 are further connected drive circuits 77, 78 and 79 driving the Y-axis motor 15, the X-axis motor 25 and the Z-axis motor 34, and the like. Based on the cutting or printing data, the control circuit 71 controls the Y-axis motor 15, the X-axis motor 25, the Z-axis motor 34 and the like so that a cutting or printing operation is automatically executed for the object S on the holding sheet 10.

The control circuit 71 of the example constitutes a processing data generation unit which generates the cutting data and the printing data based on the image data. The cutting data and the printing data will be collectively called “processing data” hereinafter. Additionally, the cutting operation and the printing operation both controlled by the control circuit 71 will be collectively called “processing operation” hereinafter.

The cutting data will be described with an exemplified case where patterns printed on the object S are cut. More specifically, the object S is a piece of paper on which are printed a pattern α of “heart,” a pattern β of “circle” and a pattern γ of “square.” The paper is an object to be read and to be cut. Image data of the object S is obtained by the above-described scanner 6. Furthermore, data indicative of outlines of the patterns α to γ is generated on the basis of the image data.

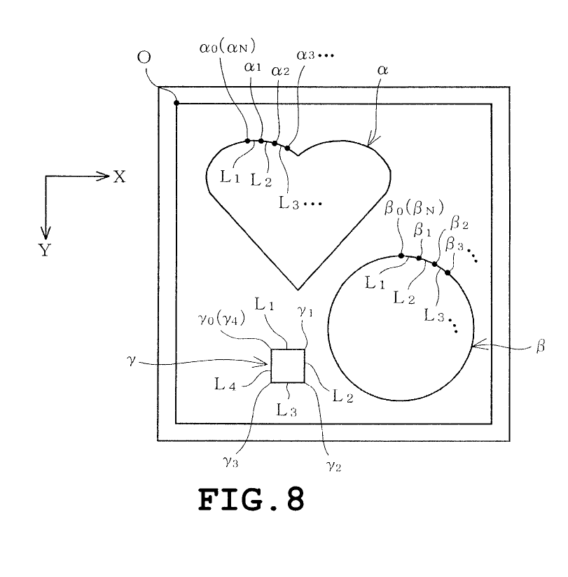

More specifically, as shown in FIG. 5, data of coordinate values of apexes α₀, α₁, α₂ and α₃ is extracted from line segments composing an outline of the pattern α. The apexes α₀ to α₃ include one in which X and Y coordinates are minimum (upper left side in FIG. 8). Furthermore, the outline of the pattern α includes an arc-shaped portion, which is divided at predetermined intervals, so that coordinate values of the apexes are calculated.

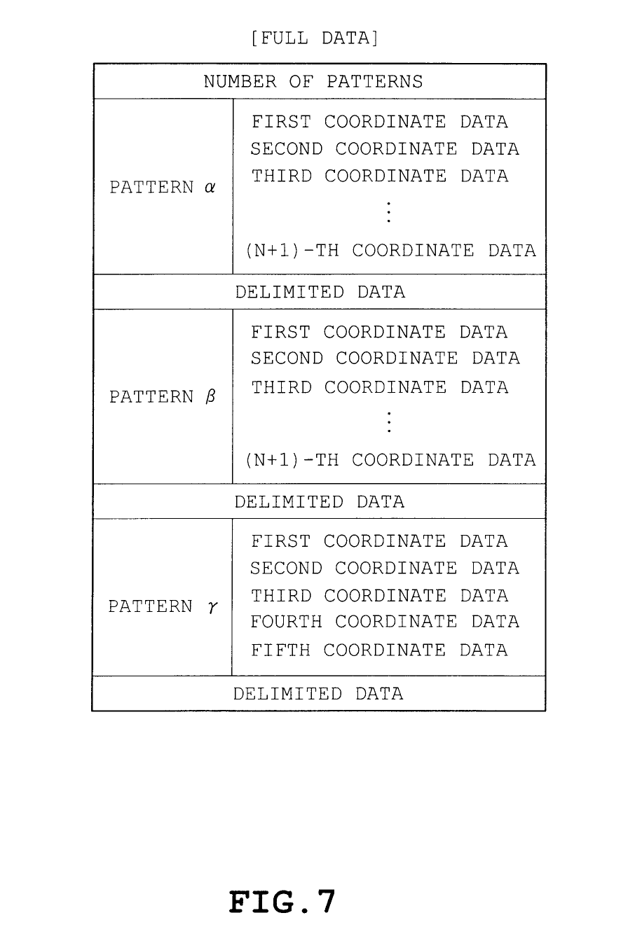

Thus, cutting line data is generated which is used to form a cutting line composed of line segments L1, L2, L3 and . . . connecting among the cutting start point α₀, apex α₁, apex α₂, and cutting end point α_{N}. The cutting line data of the pattern α has first coordinate data, second coordinate data, third coordinate data, . . . (N+1)-th coordinate data corresponding to the cutting start point α₀, apex α₁, apex α₂, and cutting end point α_{N} respectively (see FIG. 7).

Regarding line segments composing an outline of pattern β, too, a cutting start point β₀ and a cutting end point β_{N} are set in the same manner as the pattern α. The pattern β has an outline with a circumference which is divided at predetermined intervals, and coordinate values of apexes β₀ . . . are calculated. As a result, the cutting line data is generated which forms a cutting line of the “circle” composed of line segments L1, L2, L3, . . . connecting a cutting start point β₀, apex β₁, apex β₂, and cutting end point β_{N}. The cutting line data of the pattern β has first coordinate data, second coordinate data, third coordinate data, . . . (N+1)-th coordinate data corresponding to the cutting start point β₀, apex β₁, apex β₂, and cutting end point β_{N}, respectively (see FIG. 7).

Regarding line segments composing an outline of the pattern γ, too, data of coordinate values of apex γ₀, apex γ₁, apex γ₃ and apex γ₄ is extracted. A left upper apex in FIG. 8 is set as a cutting start point γ₀ and cutting end point γ_{N}. As a result, the cutting line data is generated which forms a cutting line of the “square” composed of line segments L1, L2, L3, connecting a cutting start point γ₀, apex γ₁, apex γ₂, and cutting end point γ_{N}. The cutting line data of the pattern γ has first coordinate data, second coordinate data, third coordinate data, . . . (N+1)-th coordinate data corresponding to the cutting start point γ₀, apex γ₁, apex γ₂, and cutting end point γ_{N}, respectively (see FIG. 7).

FIG. 7 is a conceptual diagram showing cutting data (full data) of the patterns α to γ. The cutting data includes delimited data suffixed to the cutting line data of the patterns α to γ. The cutting data also includes data of number of patterns and display data. The number of patterns is a total number of patterns α to γ (three in this case).

The control circuit 71 causes the apparatus to execute a cutting operation to cut the patterns α, β and γ sequentially in this order, based on the above-described cutting data. More specifically, firstly, the cutter C is relatively moved to the XY coordinates of the cutting start point α₀, by the transfer mechanism 7 and the head moving mechanism 8. The blade edge C1 of the cutter C is then caused to penetrate through the cutting start point α₀ part of the object S by the up-down drive mechanism 33. In this state, the blade edge C1 is relatively moved by the transfer mechanism 7 and the head moving mechanism 8 so as to connect linearly among the apexes α₁, α₂, α₃ . . . sequentially. Thus, the line segments L, L2, L3 and L4 are cut sequentially continuously with the result that the outline of the pattern α of “heart” is cut out.

The other patterns β and γ are also cut out based on the cutting line data in the same manner as described above. Furthermore, based on the delimited data suffixed to each cutting line data, the blade edge C1 of the cutter C is departed from the object S by the up-down drive mechanism 33 every time the cutting of cutting line is finished.

The printing data will be described in the same manner as described with an exemplified case where the patterns α to γ on the object S are printed. The printing data includes data of the number of patterns, printing line data, color data, delimited data and display data.

The printing line data of the patterns α to γ is generated on the basis of the same image data of the object S as in the same manner as described above cutting line data. Accordingly, coordinate data is generated which corresponds to the printing and the cutting on the basis of coordinate values of the apexes of the patterns α to γ extracted from the image data. As a result, printing line data of the pattern α has coordinate data including the start and end points of the line segments L1 to L4 shown in FIG. 8, which points are represented as XY coordinates. Printing line data of the patterns β and γ also has coordinate data including the start and end points of the line segments L1 . . . , which points are represented as XY coordinates. The color data includes color information (RGB values, for example) of the patterns α to γ obtained from the image data. A type of the color of the pen P is specified by the color information. The color date is set for every one of the patterns α to γ so as to correspond to the printing line data.

In the printing, the cartridge 4p of the pen P of the relevant type is displayed on the display 9a on the basis of the color data. The user attaches the cartridge 4p to the cartridge holder 32 while viewing displayed contents on the display 9a. The control circuit 71 executes the above-described printing operation and relatively moves the pen P based on the printing line data, whereby the line segments L1 . . . are plotted sequentially in this order. As a result, the patterns α, β and γ are printed along the outlines of the patterns α to γ of the object S respectively. Limited data is suffixed to the printing line data of the patterns α to γ respectively. The pen tip P1 is departed from the object S by the up-down drive mechanism 33 every time the plotting of the patterns α to γ is completed on the basis of the delimited data.

Thus, in the processing apparatus 1, processing data is generated from the image data of the patterns α to γ of the object S. The processing is executed on the basis of the generated processing data, with the result that the object S can be cut or printed.

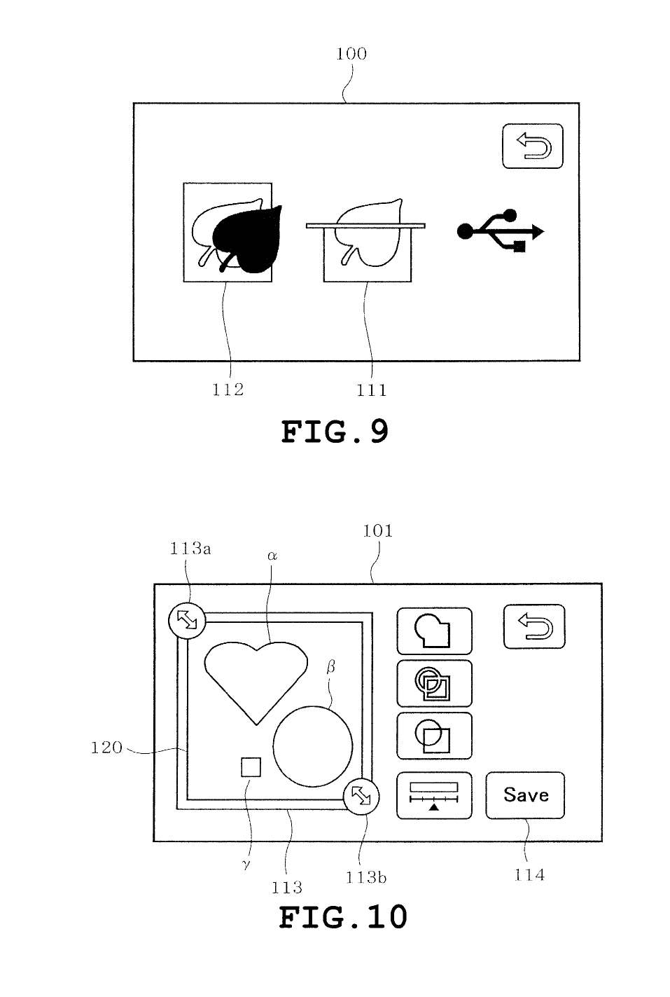

A second mode refers to a mode in which the above-described reading and the processing on the basis of the generated processing data are continuously executed by the control circuit 71 in the processing apparatus 1. The object S affixed with the patterns α to γ is to be read and processed in the second mode. The processing apparatus 1 of the example is provided with a first mode as well as the second mode. In the first mode, generated processing data is stored in a storage unit such as the EEPROM 74 without execution of a processing operation after the reading by the control circuit 71. In generating the processing data in each mode, screens displayed on the display 9a will be described with reference to FIGS. 9 to 13.

FIG. 9 shows a mode switching screen 100 for the user to switch the operating mode to a desirable mode. The mode switching screen 100 is provided with soft keys including a first mode switching key 111 and a second mode switching key 112. The user touches the touch switch corresponding to the first or second mode switching key 111 or 112 with his/her finger. The operating mode is switched to the first or second mode by the touch operation. The display 9a, the touch panel 9c and the control circuit 71 constitute a mode switching unit which switches between the first and second modes.

FIG. 10 shows a first read screen 101 which is displayed after a reading operation has been executed in the first mode. The first read screen 101 is provided with a preview image area 113 displaying an image of the object S read by the reading operation, a save key 114 and the like. When the save key 114 is touched, generated processing data is stored in a storage unit (the EEPROM 74, for example).

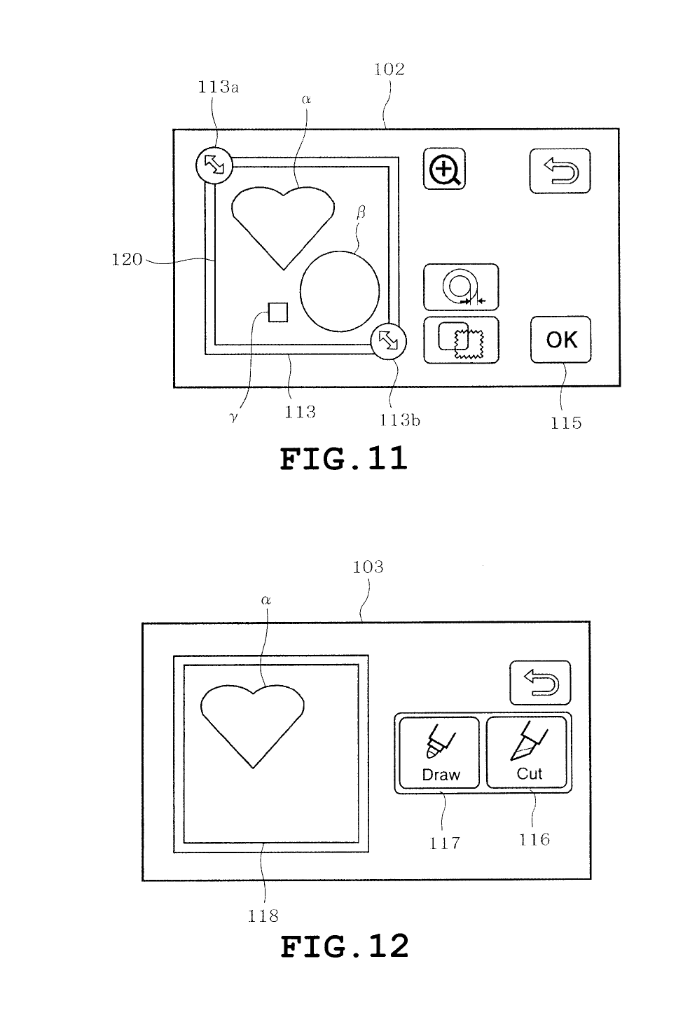

On the other hand, FIG. 11 shows a second read screen 102 which is displayed after a reading operation has been executed in the second mode. The second read screen 102 is provided with a preview image area 113, an OK key 115 and the like. When the OK key 115 is touched, a processing start screen 103 as shown in FIG. 12 is displayed. The processing start screen 103 is provided with a preview image area 118, a cut key 116, a drawing key 117 and the like. When either key 116 or 117 is touched, a processing operation starts based on processing data.

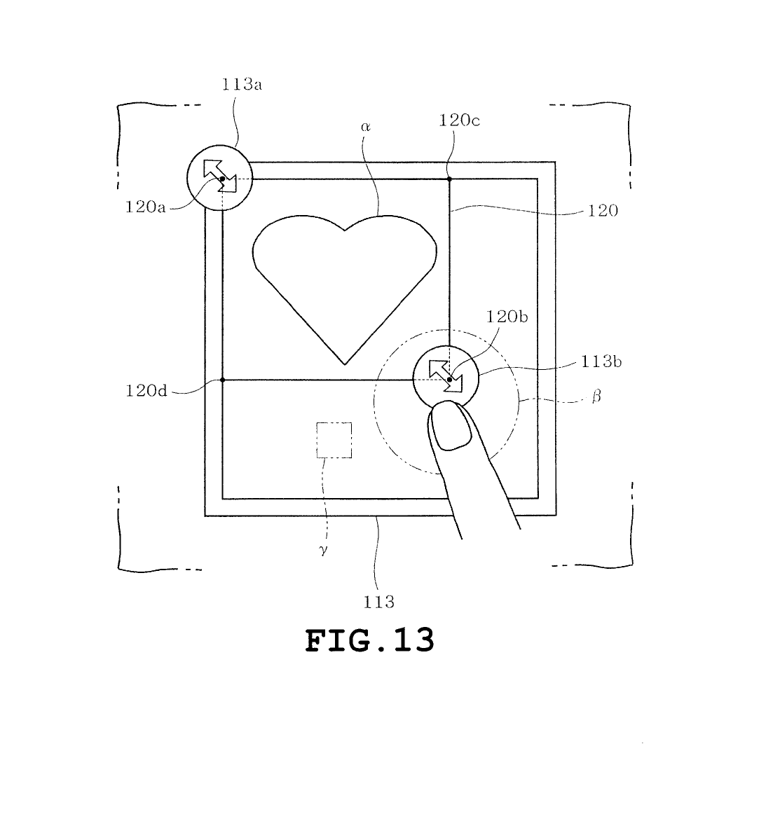

The preview image area 113 displayed on the first and second read screens 101 and 102 represents the object S on a suitable scale based on the image data. The preview image area 113 is provided with range setting parts 113a and 113b which designate a desired range (an area range 120) as shown in FIG. 13. The range setting parts 113a and 113b are located at diagonal positions (apexes 120a and 120b) of a rectangle defining a range of closed area (the area range 120). The range setting parts 113a and 113b are dragged with the touch operation of the range setting parts 113a and 113b. The drag cart optionally set the size and location of the rectangle or the area range 120.

More specifically, when the image as shown in FIG. 1.3 is displayed on the display 9a, horizontal or vertical coordinate axes on the touch panel 9c on the screen correspond to the aforementioned X and Y directions respectively. The touch panel 9c supplies X-Y coordinates which are coordinate information of the touch position supplied by the touch operation. The control circuit 71 carries out an operation to obtain coordinates of the apexes 120a to 120d of the dragged range setting parts 113a and 113b, based on coordinate information supplied from the touch panel 9c. This specifies coordinates of the area range 120 on the object S corresponding to the apexes 120a to 120d. The touch panel 9c should not be limited to the resistance detection type but may be of any type that can specify the touch position. Furthermore, the above-mentioned touch operation and drag operation may be carried out with a touch pen or the like.

The control circuit 71 determines whether or not the patterns α to γ partially or wholly spread out of the area range 120, based on the coordinates of the specified area range 120 and image data of the object S. As a result, the control circuit 71 selects, as patters effective to generate processing data, the patterns except for one or more patterns spreading out of the area range 120, from the image of the object S. More specifically, the pattern α is within the area range 120 and the pattern β partially expands out of the area range 120, as shown in FIG. 13. In this case, only the pattern α is selected as the effective pattern. Thus, the user can easily designate a desired pattern effective to generate the processing data from the patterns α to γ by optionally setting the area range 120. The processing data of the generated pattern α is stored in the EEPROM 74 according to the mode switched by the mode switching unit or a processing operation is executed for the object S based on the processing data. The image of pattern α selected on the basis of the area range 120 is displayed in the preview image area 118 of the processing start screen 103 as shown in FIG. 12.

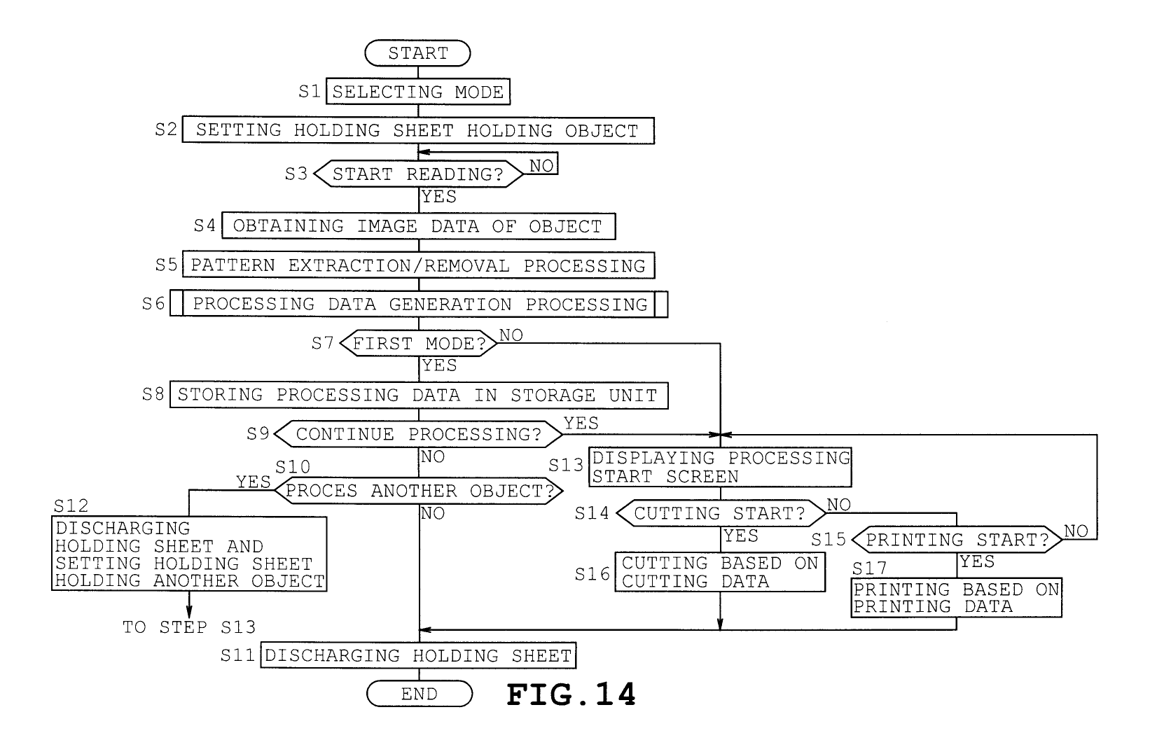

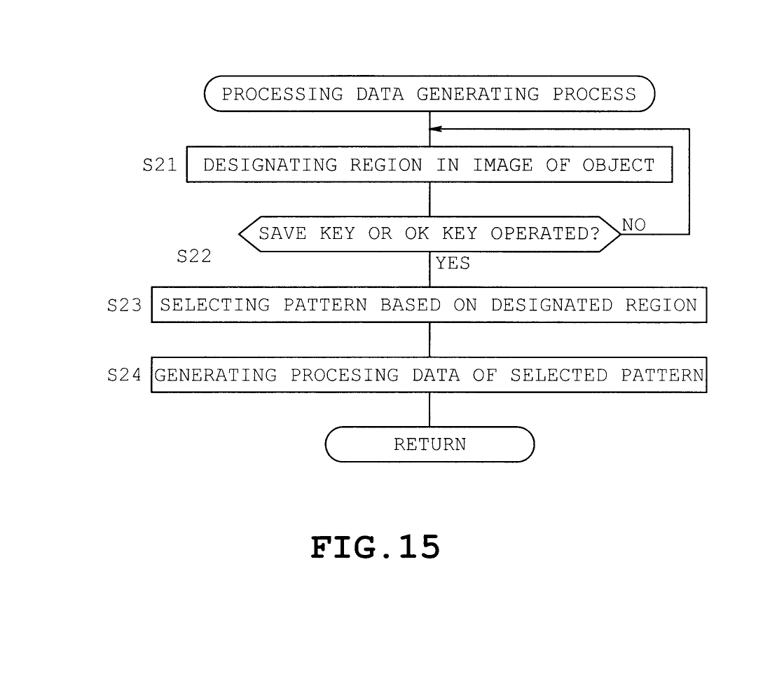

The operation of the above-described configuration will be described with reference to FIGS. 14 and 15. The flowcharts of FIGS. 14 and 15 illustrate a sequential flow of the data processing program including a processing operation the control circuit 71 causes to execute. When desiring to carry out processing by the use of the object S affixed with the patterns α to γ, the user firstly causes the display 9a to display the mode switching screen 100 as shown in FIG. 9. The user then touches the switching key 111 or 112 to select a desired mode (step S1). The user then attaches the object S (paper, for example) to the holding sheet 10 as shown in FIG. 1, setting the holding sheet 10 onto the platen 3 of the processing apparatus 1 (step S2).

When detecting a distal end of the holding sheet 10 by a sheet detection sensor 76, the control circuit 71 sets the left corner of the adhesive layer 10v of the holding sheet 10 as the origin O. When start of reading is instructed by the operation of the switch of the operation switch device 9b (YES at step S3), the scanner 6 performs a scanning operation (step S4). In this case, while causing the transfer mechanism to move the holding sheet 10 in the Y direction, the control circuit 71 causes the scanner 6 to repeatedly carry out the reading operation (scanning in the X direction) in synchronization with the movement of the holding sheet 10. Image data of the object S is generated by the reading operation, whereby the first read screen 101 as shown in FIG. 10 or the second read screen 102 as shown in FIG. 11 is displayed on the display 9a (step S5). In this case, the first or second read screen 101 or 102 includes images of the patterns α to γ of the object S. The control circuit 71 subsequently proceeds to step S6 for a processing data generating process (see FIG. 15).

In the processing data generation process, the size and position of the area range 120 in the preview image area 113 of the read screens 101 and 102 are set optionally. As the result of the setting, patterns can be selected regarding processing data to be generated (step S21). More specifically, when the operating mode has been changed to the first mode at step S1, the user drags the range setting parts 113a and 113b in the preview image screen 113 of the first read screen 101. Assume now that with the dragging operation, the whole pattern γ is located outside the area range 20, and the pattern β partially spreads out of the area range 120, as shown in FIG. 13. In this case, the control circuit 71 renders non-display the pattern γ outside the area range 120 and the partially spreading pattern β. Alternatively, these patterns α and γ may be caused to gray out. Although the patterns α and β are shown by the two-dot chain line in FIG. 13, the patterns α and γ may be displayed in any manner that is discriminable between the patterns α and γ, and the other pattern β. As a result, the user can confirm that the effective pattern to generate processing data is the pattern α.

When the save key 114 of the first read screen 101 has been touched (YES at step S22), the control circuit 71 selects the pattern α contained in the area range 120 (step 23). The control circuit 71 processes the image data of the object S by a known image processing manner thereby to extract data of coordinate values of apexes α₀, α₁, α₂, . . . regarding line segments composing the selected pattern α (see FIG. 8). As a result, cutting line data is generated regarding the pattern α. The generated cutting line data has first coordinate data, second coordinate data, third coordinate data, and (N+)-th coordinate data corresponding to cutting start point α₀, apex α₁, . . . cutting end point (N+1) respectively (see FIG. 7). Furthermore, the control circuit 71 suffixes limiter data to the cutting line data and adds display data to the cutting line, thereby generating cutting data of the pattern α (step S24).

In this case, furthermore, the control circuit 71 generates coordinate data represented by X-Y coordinates of apexes α₀, α₁, α₂, . . . of the extracted line segments regarding printing line data. The control circuit 71 suffixes limiter data to the printing line data and adds display data to the printing line, thereby generating printing data of the pattern α. Subsequently, the control circuit 71 returns to step S7 in FIG. 14.

Thus, when the operating mode has been switched to the first mode (YES at step S7), the control circuit 71 stores cutting and printing data of the generated pattern α in a nonvolatile storage unit such as the EEPROM 74 (step S8). When the currently set object S is not processed (NO at step S9 and NO at step S10), the holding sheet 10 is transferred forward by the transfer mechanism 7 thereby to be discharged (step S1). As a result, even when processing ends, the control circuit 71 can read the processing data of the pattern α from the EEPROM 74. Accordingly, the pattern α can be applied to another object based on the processing data of the pattern α.

Furthermore, when the operating mode has been switched to the first mode (YES at step S7) and the user wishes to apply the pattern α to the currently set object S (YES at step S9), the control circuit 71 causes the display 9a to display the processing start screen (see FIG. 12) and the user touches the cut key 116 or the draw key 117 on the processing start screen 103 (YES at step S14 or YES at step S15). As a result, the pattern α is cut from or printed on the object S (step S16 or S17). The procedure of the cutting or printing will be described later.

Furthermore, when the operating step has been changed to the first mode (YES at step S7), the processing of the pattern α can be applied to another object instead of the currently set object S (NO at step S9 and YES at step S10). In this case, the holding sheet 10 is once discharged by the transfer mechanism 7. The object S is removed from the discharged holding sheet 10 by the user (step S12). The user then affixes another object to the holding sheet 10 and sets the holding sheet 10 onto the processing apparatus 1, causing the display 9a to display the processing start screen 103 (step S13). As a result, when either key 116 or 117 is touched, the pattern α can be cut from or printed on the object other than the object S (steps S14 to S17).

Even when the operating mode has been changed to the second mode at step S1, a desired pattern α can be selected from the patterns α to γ at step S6. More specifically, the user drags the range setting parts 113a and 113b on the second read screen 102 in FIG. 11 to set the desired pattern α so that the pattern α is surrounded by the area range 120 (step S21 in FIG. 15). When the OK key 115 is touched on the second read screen 102 (YES at step S22), the control circuit 71 selects only the pattern α in the area range 120 as described above (step S23). As a result, the control circuit 71 generates cutting data and printing data regarding the selected pattern α in the same manner as in the first mode (step S24). Subsequently, the control circuit 71 returns to step S7 in FIG. 14.

Thus, when the operating mode has been switched to the second mode (NO at step S7), the control circuit 71 causes the display 9a to display the processing start screen 103 containing an image of the pattern α whose processing data has been generated (step S13; and see FIG. 12). When the cut key 116 is touched on the processing start screen 103, the control circuit 71 determines whether or not the cartridge 4c of the cutter C has been attached, based on the detection signals of the type detection sensors 63A to 63C. When the cartridge 4c is attached and start of the processing is instructed by the operation of the switch of the operation switch device 9b (YES at step S14), the cutting operation is executed based on the cutting data of the generated cutting data of the pattern α (step S16). As a result, the pattern α attached to the object S is cut, whereby the pattern α is cut out of the object S by the cutter C.

On the other hand, when the draw key 117 is touched on the processing start screen 103, the control circuit 71 determines whether or not the cartridge 4p of the pan P has been attached, based on the detection signals of the type detection sensors 63A to 63C. When the cartridge 4p is attached and start of the processing is instructed by the operation of the switch of the operation switch device 9b (YES at step S15), the printing operation is executed based on the generated printing data of the pattern α (step S17). As a result, drawing is carried out along the pattern α on the object S by the pen P.

Thus, upon end of processing of the pattern α attached to the object S, the control circuit 71 causes the transfer mechanism 7 to transfer the holding sheet 10 forward to discharge the holding sheet 10 (step S11), whereby the sequence of processing is completed (END).

As described above, the processing apparatus 1 includes the processing data generation unit which generates the processing data to process the object S based on the image data obtained by the image obtaining unit. The processing apparatus 1 further includes the mode switching unit which switches between the first mode in which the processing data generated by the processing data generation unit is stored in the storage unit provided in the processing apparatus 1 without execution of the processing operation by the control unit and the second mode in which the control unit executes the processing operation based on the processing data. Storage of the processing data in the storage unit or processing of the object S on the basis of the processing data is selectively executed according to the mode switched by the mode switching unit.

According to the above-described configuration, the processing data is generated by the processing data generation unit based on the image data of the object S obtained by the image obtaining unit. In this case, when the operating mode is switched to the first mode by the mode switching unit, the generated processing data can be stored in the storage unit and can be used for the processing of another object. On the other hand, when the operating mode is switched to the second mode, the object S can be promptly processed based on the generated processing data. Accordingly, the operating mode can be switched to a desired mode by the mode switching unit, whereby the object can be processed easily.

When the operating mode has been changed to the first mode by the mode switching unit, the control unit is configured to read the processing data stored in the storage unit to thereby be capable of executing the processing operation based on the processing data (see steps S9, S10 and S12). According to this configuration, the object S can also be processed in the first mode, so that the usability of the processing apparatus can be improved.

The control circuit 71, the display 9a and the touch panel 9c constitute the area designating unit which designates a desired area (the area range 120, for example) in the image of object S represented by the image data obtained by the image obtaining unit. Furthermore, the processing data generation unit generates the processing data based on the image data of the area designated by the area designating unit. According to this configuration, when a desired area in the image of the object S is designated by the area designating unit, the processing data is generated based on the image data of the designated area. Accordingly, since the processing data can be prevented from being generated uneconomically, a troublesome work such as confirmation, deletion or saving of the processing data can be eliminated.

A plurality of the area range 120 may be provided in the preview image area. Furthermore, the control circuit 71, the display 9a and the touch panel 9c constitute the area setting unit which sets the range of one or more of the closed areas such as the area range 120. According to the range setting unit, a desired area can be easily set in the image of the object S.

The control circuit 71 constitutes a selecting unit (a determination unit) which selects, as an effective pattern, one or more of the patterns contained in the range of area of the image of the object S, set by the range setting unit, except for one or more patterns partially spreading out of the area range. The processing data generation unit generates processing data of the effective pattern selected by the selecting unit. According to the configuration, one or more patterns partially spread out of the area range in setting the range of area in the image of the object S, one or more patterns except for the patterns partially spreading out of the area range are selected as effective patterns. Conversely, the pattern even partially spreading out of the area range is not selected as the effective pattern. Accordingly, a desired pattern can be easily designated in the patterns of the object S.

The processing apparatus 1 includes the display unit which displays an image of the object S represented by the image data. The area designating unit is configured to be capable of designating a desired area in the image of the object S displayed on the display unit. According to the configuration, the area to be designated in the image of the object S can be easily understood visually.

The processing head 5 includes a printing unit which prints the object S. As a result, the object S can be printed by the processing apparatus 1 based on the generated processing data.

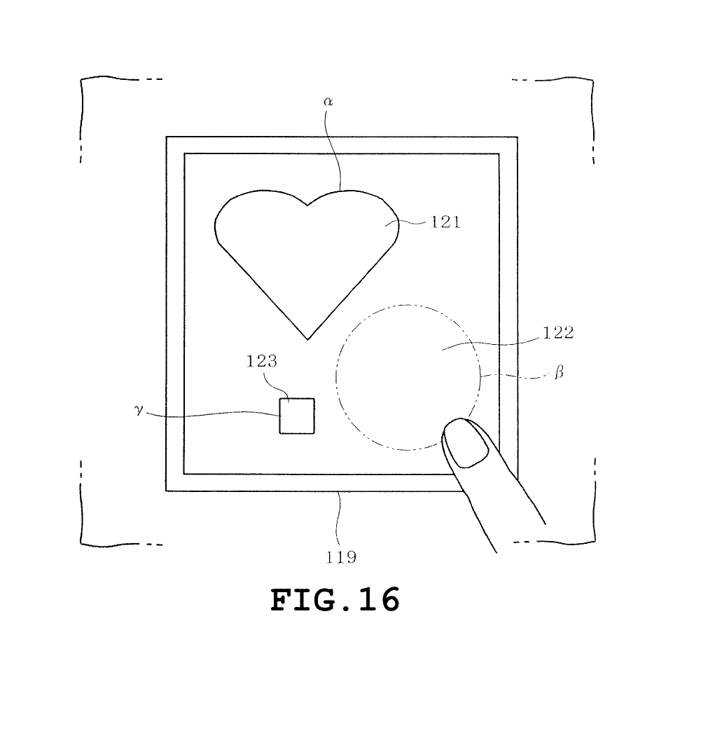

FIG. 16 illustrates a second embodiment. In the second embodiment, identical or similar parts are labeled by the same reference symbols as those in the first embodiment and the description of these identical parts will be eliminated. Only the difference from the first embodiment will be described in the following.

The range setting parts 113a and 113b (the area range 120) are eliminated in the preview image area 119 in the second embodiment. In the preview image area 119, closed areas 121 to 123 are designated by the user. The closed areas 121 to 123 have contour lines which are outlines of the patterns α to γ respectively. More specifically, the control circuit 71 specifies position coordinates on the object S, corresponding to coordinate information supplied by the touch operation on the touch panel 9c, at step S21. The control circuit 71 then determines whether or not any one of the closed area 121 of the pattern α, the closed area 122 of the pattern β and the closed area 123 of the pattern γ has been touched, based on the specified position coordinates on the object S and image data of the object S. As exemplified in FIG. 16, when determining that the closed area 122 of the pattern β has been touched, the control circuit 71 grays out the pattern β. The control circuit 71 further returns the pattern β to its original state when determining that the closed area 122 of the pattern β has been touched again.

The control circuit 71 further selects the pattern which is not currently grayed out, as an effective pattern (step S23) when the save key 114 on the read screen 101 (the OK key 115 on the read screen 102) has been touched (YES at step S22). Thus, the control circuit 71 generates cutting data of the contour line of the selected effective pattern and printing data (step S24).

As described above, the area designating unit in the second example is configured to be capable of designating the closed areas 121 to 123 which have, as contour lines, the outlines of the patterns α, β and γ in the image of the object S. The processing data generation unit generates processing data of the contour line of the closed area designated by the area designating unit. According to the configuration, the closed areas 121 to 123 of the patterns α, β and γ in the image of the object S, whereby the patterns α, β and γ whose processing data is to be generated can be easily selected.

The above-described examples should not be restrictive but may be modified or expanded as follows. Although the invention is applied to the processing apparatus in the foregoing examples, the invention may be applied to various apparatuses provided with a cutting unit and/or a printing unit.

The image acquisition unit should not be limited to the CIS (the scanner 6). A charge-coupled device (CCD) may be used as the image acquisition unit. Furthermore, the area can be designated by the area designating unit in both first and second modes in the foregoing embodiments. However, the area may be designated in either first or second mode.

The data processing program stored in the storage unit of the processing apparatus 1 may be stored in a non-transitory computer-readable storage medium including a USB flash memory, CD-ROM, flexible disc, DVD and flash memory. In this case, when the data processing program stored in the storage medium is read by computers incorporated in various processing apparatuses provided with a cutting unit and/or a printing unit thereby to be executed, the same advantageous effects as achieved by the above-described examples can be achieved by these processing apparatuses.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An apparatus comprising:
a cartridge holder configured to receive a pen or a cutter;
a platen configured to receive an object;
a moving mechanism configured to move the cartridge holder in a direction that the cartridge holder comes close to the platen;
a read unit configured to read image data from the object;
a receiving unit configured to receive an instruction to set a first mode or a second mode; and
a processor configured to instruct the apparatus to:
generate processing data to move the moving mechanism based on the image data;
store the processing data in a storage device of the apparatus in response to receiving the instruction to set the first mode; and
instruct the moving mechanism to move the cartridge holder close to the platen, based on the processing data, in response to receiving the instruction to set the second mode.

2. The apparatus according to claim 1, further comprising an area designating unit configured to receive a designation of a desired area in an image of the object represented by the image data, wherein the processor is further configured to instruct the apparatus to:
generate the processing data based on image data of the area designated by the area designating unit.

3. The apparatus according to claim 2,
wherein the area designating unit is configured to receive a designation of a size of the range with one or more closed areas in the image of the object serving as a range of the area.

4. The apparatus according to claim 3, wherein the processor is further configured to instruct the apparatus to:
determine, as an effective pattern, a pattern located within the range of the area, out of patterns contained in the designated range of the area; and
generate processing data of the pattern determined as the effective pattern.

5. The apparatus according to claim 2,
wherein the area designating unit is configured to designate a closed area having a contour line which is an outline of the pattern in the image of the object,
wherein the generating the processing data comprises generating the processing data of the contour line of the closed area designated by the area designating unit.

6. The apparatus according to claim 2, further comprising:
a display unit,
wherein the processor is further configured to instruct the apparatus to:
display, on the display unit, the image of the object represented by the image data, and
wherein the area designating unit is configured to designate the desired area in the image of the object displayed by the display unit.

7. A non-transitory computer-readable medium for an apparatus comprising:
a cartridge holder configured to receive a pen or a cutter;
a platen configured to receive an object;
a moving mechanism configured to move the cartridge holder in a direction that the cartridge holder comes close to the platen;
a read unit configured to read image data from the object; and
a receiving unit configured to receive art instruction to set a first mode or a second mode,
wherein the computer-readable medium storing computer-readable instructions, when executed by a processor of the apparatus, cause the apparatus to:
generate processing data to move the moving mechanism based on the image data;
store the processing data in a storage device of the apparatus in response to receiving the instruction to set the first mode; and
instruct the moving mechanism to move the cartridge holder close to the platen so that the object is processed, based on the processing data, when the receiving unit receives the instruction to set the second mode.

8. The medium according to claim 7, wherein the apparatus further comprises an area designating unit configured to receive a designation of a desired area in an image of the object represented by the image data, and wherein the computer-readable instructions, when executed by the processor, further cause the apparatus to:
generate the processing data based on image data of the area designated by the area designating unit.

9. The medium according to claim 8, wherein the computer-readable instructions, when executed by the processor, further instruct the area designating unit to receive a designation of a size of the range with one or more closed areas in the image of the object serving as a range of the area.

10. The medium according to claim 9, wherein the computer-readable instructions, when executed by the processor, further cause the apparatus to:
determine, as an effective pattern, a pattern located within the range of the area, out of patterns contained in the designated range of the area; and
generate processing data of the pattern determined as the effective pattern.

11. The medium according to claim 8, wherein the area designating unit is configured to designate a closed area having a contour line which is an outline of the pattern in the image of the object, and wherein the generating the processing data comprises generating the processing data of the contour line of the closed area designated by the area designating unit.

12. The medium according to claim 8, wherein the apparatus further comprises a display unit, wherein the computer-readable instructions, when executed by the processor, further cause the apparatus to display, on the display unit, the image of the object represented by the image data, and wherein the area designating unit is configured to designate the desired area in the image of the object displayed by the display unit.

13. An apparatus comprising:
a pen or a cutter;
a platen configured to receive an object;
a moving mechanism configured to move the cartridge holder in a direction that the pen or the cutter comes close to the platen;
a read unit configured to read image data from the object;
a receiving unit configured to receive an instruction to set a first mode or a second mode; and
a processor configured to instruct the apparatus to:
generate processing data to move the moving mechanism based on the image data;
store the processing data in a storage device of the apparatus in response to receiving the instruction to set the first mode; and
instruct the moving mechanism to move the pen or the cutter close to the platen so that the object is processed, based on the processing data, in response to receiving the instruction to set the second mode.
